(19) United States
(12) Patent Application Publication
(10) Pub. No.: US 2008/0046285 A1
(43) Pub. Date: Feb. 21, 2008

(54) Method and system for real-time emergency resource management

(76) Inventors: Patrick J. Greischar, Whitefish Bay, WI (US); Edward Barthell, Mequon, WI (US); Robert Hedgcock, Oconomowoc, WI (US); Elaine Schweitzer, Whitefish Bay, WI (US); David R. Colwell, Pewaukee, WI (US); Chris Felton, Menomonee Falls, WI (US)

Correspondence Address: TRIANGLE PATENTS, P.L.L.C., P.O. BOX 28539, RALEIGH, NC, 27611-8539, US

(21) Appl. No.: 11/506,850

(22) Filed: Aug. 18, 2006

(51) Int. Cl. G06Q 10/00; G05B 19/418

(52) U.S. Cl. 705/2; 705/8

(57) ABSTRACT

The present invention provides a system and a method for providing information about resource availability, especially during an emergency such as a natural disaster. The system stores resource information about multiple facilities, across cities, counties, states and even countries. Such information can be provided to designated users based on specified access levels for the user and the resource information. Further, the system is able to exchange the resource availability information with external systems and databases. The resource information is also automatically updated to reflect the most current information. The system is useful in directing resources to participate in an emergency.

### CROSS-REFERENCE TO RELATED APPLICATIONS

This non-provisional utility patent application claims the benefit of one or more prior filed co-pending non-provisional applications, a reference to each such prior application is identified as follows: application Ser. No. 11/226,875, titled “Electronic Data Management System for Emergency First-Responders and Method of Use”, Attorney Docket #7448-001, filed on Sep. 14, 2005.

### BACKGROUND OF THE INVENTION

1. Field of the Invention

The present invention relates generally to a resource management system for use by personnel managing an incident. Additionally, the present invention relates to a computer system and method for emergency personnel to efficiently direct the movement of patients, evacuees, people, or those injured as well as resources and equipment to the appropriate resources on the basis of the availability of the resources best suited according to the needs of the patients, evacuees, people or those injured.

2. Description of the Prior Art

A multiple-victim disaster or an emergency can overwhelm ill-prepared local or state officials. This is especially true if resources available to handle the disaster or the emergency are constrained. In the case of a medical disaster, disaster victims may be routed to medical facilities where the medical resources (number of available beds, facilities to treat a certain type of victims) are limited or already in use for treating similar victims from the same disaster location or another disaster location. In such a case, there may be other medical facilities that are equipped to accommodate the victims, but may be unutilized for a number of reasons, primarily lack of knowledge about the availability of resources at a facility.

Hence, there is a need for a system that tracks in real-time the availability of resources across multiple facilities in order to better direct victims of an emergency or disaster to these resources. Additionally, the system should be able to categorize these resources and the patients/victims needs so that it can better direct the patients/victims according to the type of resource required to treat the patient/victim. The system should also be able to track the availability of resources from multiple facilities across regions, cities and in certain cases across states. This system should be accessible at the emergency location or at multiple locations in case of a natural disaster to enable central tracking of the resources. The system should also support communication of resource status and availability across one or many users in the region, city, county, state or other response territory.

One such system is described in U.S. Publication No. 20040138925, titled “Resources utilization management system and method of use”. This patent application describes a resource utilization system that graphically depicts utilization levels of resources in a hospital. Examples of the different types of resources include beds, rooms as well as human resources such as medical staff, physicians, etc. The application further describes the method of managing these resources by first assigning these resources to subjects such as patients. During the assignment, the system displays the utilization of the resources giving an indication to the user about the availability of the resources.

U.S. Publication No. 20030074222, titled “System and method for Managing Patient Bed Assignments and Bed Occupancy in a Health Care Facility” describes a computer implemented system for managing the assignment of beds in a medical facility. The claimed system functions in conjunction with an admission/discharge/transfer system and keeps a track of the beds in a medical facility and the assignment of beds to incoming patients. It also displays a real-time status of the beds available in the facility and the beds that are currently assigned to patients in the facility.

U.S. Publication No. 20040243446, titled “Method and a System for Optimizing Hospital Beds and Ambulance Allocations via a Computer Network” describes a computer based system that enables users to view the real-time status of beds available in a medical facility such as a hospital. Further, the system enables the hospital to communicate this status to an ambulance that is directing one or more patients to the hospital. If the hospital does not have the available capacity to accommodate the patients being transported in the ambulance, then the ambulance is redirected to a second facility or hospital.

From the above discussion, it is clear that there is a need for a system that will enable tracking availability of resources from multiple facilities. The system should also be able to list resources by type so that availability of a certain type of resource, such as, bed capacity by triage category is readily available. Additionally, the system should be able to allow only certified users and regions to view resource information from other regions. The system should also allow access to information to be restricted based on a user's role, rights, facility affiliation, or region.

### SUMMARY OF THE INVENTION

A first aspect of the present invention is to provide a method for providing resource information comprising availability of resources associated with one or more facilities in one or more regions to a user associated with at least one region by providing the resource information for at least one first region along with a list of at least one second region that can access the resource information for the at least one first region, the at least one user sending a request for viewing resource information for the at least one first region, verifying that the at least one region that the at least one user is associated with is the in the list of at least one second region with access to the resource information of the at least one first region and providing the resource information of the at least one first region to the least one user.

A second aspect of the present invention is to provide a method for providing resource information comprising availability of resources in one or more facilities in one or more regions to a user associated with at least one region during an emergency such as one involving multiple victims, by providing the resource information for at least one region along with a list of at least one emergency that can access the resource information for the at least one first region, the user sending a request for viewing resource information for the at least one region, verifying that the at least one emergency that the user is associated with is in the list of at least one emergencies with access to the resource information being requested and providing the resource information to the at least one user.

It is yet another aspect of the present invention to provide a method for providing resource information comprising availability of resources in one or more facilities in one or more regions to at least one user associated with at least one region by providing resource information for at least one region along with a list of at least one second region that can access the resource information for the at least one first region, wherein the resource information includes data elements required by HAVE standards, the user sending a request for viewing resource information for at least one fist region, verifying that the at least one region that the user is associated with is in the list of at least one second region with access to the resource information of the at least one first region and providing the resource information to the at least one user.

It is still another aspect of the present invention to provide a system for providing resource information comprising availability of resources in one or more facilities in one or more regions to a user associated with one or more facilities comprising at least one database for storing resource information for at least one facility, an access control module for controlling access to the resource information stored in the database, at least one terminal for viewing the resource information, a network for connecting the database with the terminal and a second database for storing a list of regions that can access resource information for the at least one facility.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic view of the overall system in accordance with an embodiment of the present invention.

FIG. 2 is a schematic view of a system for providing clients with resource information, in accordance with an embodiment of the present invention.

FIG. 3 is a flowchart depicting the steps of retrieving resource information of a region by a client associated with the same region, in accordance with an embodiment of the present invention.

FIG. 4 is a flowchart depicting the steps of retrieving resource information of a region by a client associated with another region, in accordance with an embodiment of the present invention.

FIG. 5 is a flowchart depicting the steps involved in giving access to resource information to a user for a specific event, in accordance with an embodiment of the present invention.

FIG. 6 is a schematic view of the system for communicating with external state and federal resource databases, in accordance with an embodiment of the present invention.

FIG. 7 is a schematic view of the system for allowing medical facilities to update medical resource information, in accordance with an embodiment of the present invention.

### DETAILED DESCRIPTION OF THE PREFERRED EMBODIMENTS

The present invention provides a method and system for providing resource availability information across multiple facilities in one or more regions. The present system tracks medical and non-medical resources by type and provides availability information to users requesting the same. The system also allows for protecting the resource information, and the resource information is provided only to authorized users. Further, the users are only authorized to view resource information for certain specified resources. This enables the system of the present invention to restrict certain users from viewing resource information from resources that they are not authorized to view.

Administrators of the system can define resources by region. Additionally, they can define the regions for which the users are authorized to view resource information. In certain special cases, the administrators can grant access to certain users to view resource information for regions for which the users are not initially authorized. This can be done on a per user basis, for a specified time frame or for a specified medical emergency or event.

The present invention provides for tracking of medical resources including but not limited to hospital beds, hospital rooms, Emergency Medical Services such as ambulance availability, medical personnel availability, availability of medical equipment such as defibrillators, decontamination facilities, negative pressure isolation rooms, ventilators, etc. These resources are tracked across one or multiple regions. A region can be defined as a part of a town or city, a town, city, county, state and even a country. The present invention also provides for tracking of non-medical resources including but not limited to shelters, vehicles, equipment, beds and other resources such as capacity in shelters, etc.

The present invention also provides a method and a system for interacting and exchanging resource information from other systems, such as Crisis Information Management System (CIMS), Computer Aided Dispatch system (CAD), Hospital Alert Network (HAN), etc.

The present invention also provides a method and a system for gathering, aggregating, storing, and exchanging information to support regional or federal guidelines including Hospital Availability Exchange (HAVE) guidelines. The system allows users to update the status of the resources of one or more facilities that the users are associated with, and is capable of reporting resource availability in standard categories as defined by the standard, and report data back to state and federal systems in a standardized format, using one or more standardized interface methodologies. The system allows standard categories of resource availability information to be stored, accessed, and updated by authorized users.

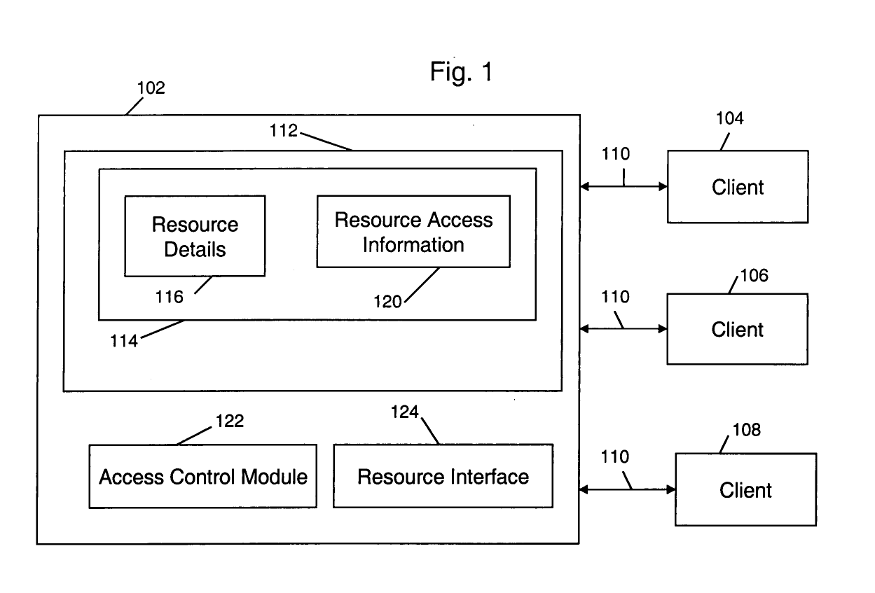

Referring now to the drawings in general, the illustrations are for the purpose of describing a preferred embodiment of the invention and are not intended to limit the invention thereto. FIG. 1 is a schematic view of the overall system in accordance with an embodiment of the present invention. Server 102 is connected to multiple clients 104, 106 and 108 via network 110. Server 102 may be any personal computer having one or processing means, storage means and memory means, as commonly known in the art. Clients 104, 106 and 108 can be personal computers, laptop computers, tablet PCs, mobile phones and other devices known in the art capable of accessing a website or running a standalone application. Clients 104, 106 and 108 access server 102 via network 110. Network 110 can be a local intranet, the internet, and the means of access the server 102 may be wired, wireless or via a mobile network.

Server 102 has database 112 residing on it. Database 112 is a database having means for storing data and organizing data into tables. Commercial examples of database 112 include Microsoft® SQL Server and Oracle®. In another embodiment of the present invention, database 112 may be separate from server 102. Database 112 may be on a second server that is connected to server 102 by means commonly known in the art.

Database 112 stores resource information 114 for one or more resources. In one embodiment of the present invention, database 112 is with a part of CIMS. In another embodiment, database 112 includes data elements specified in the Hospital Availability Exchange guidelines. Resource information 114 further comprises resource details 116 and resource access information 120. Resource details 116 include location of resource, type of resource, availability information, timing information, contact information, etc. Resource access information 120 is used to determine if users can access resource details 116. It also determines if users can search for a resource based on resource details 116. In one embodiment of the present invention, resource access information 120 stores a list of regions to which the resource details 116 will be visible. In another embodiment of the present invention, resource access information 120 stores a list of users that can view resource details 116.

Server 102 further comprises access control module 122. Access control module screens clients 104, 106 and 108 access server 102 and provides access to resource details on the basis of the resource access information 120. When a client requests to view resource information, access control module 122 first determines if client has access to resource information by matching client information with resource access information 120. In another embodiment of the present invention, clients 104, 106 or 108, request to view a list of all available resources. Access control module 122 retrieves resource details 116 for all resources that have specified access to client 104 in their resource access information 120.

Server 102 also comprises resource interface 124 that interfaces and exchanges resource information with external sources. In an embodiment, resource interface 124 can be configured to pull in resource information from multiple sources at predefined time intervals, e.g., hourly, daily, weekly, etc. In another embodiment, it can be configured to pull in information based on user requests or client requests. In a third embodiment, it can be configured to pull in information on the basis of change in resource information 114 or resource details 116. For example, if the resource level for a given resource changes, the change is automatically reflected in resource details 116 for that particular resource. In a fourth embodiment, the interface provides access to resource data for authorized systems. These outside systems may include CIMS, state and federal HAVE systems, Health Alert Networks, and other systems.

In another embodiment of the present invention, access control module 122 is not part of server 102, but is part of another server that can communicate with server 102 by means known in the art. In yet another embodiment of the present invention, resource interface 124 is not part of server 102, but is part of another server that can communicate with server 102 by means known in the art.

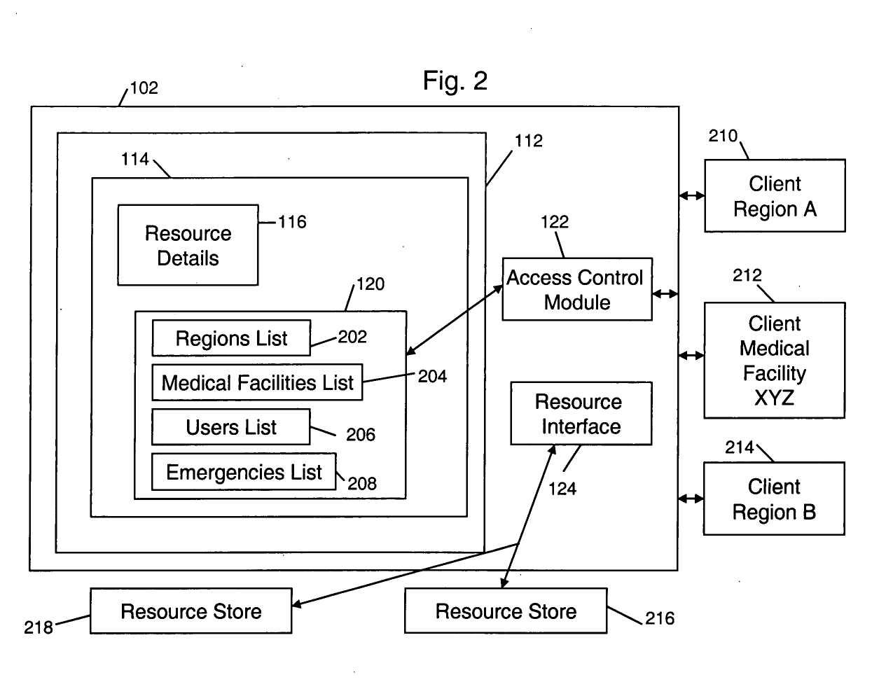

FIG. 2 is a schematic view of a system for providing clients with resource information, in accordance with an embodiment of the present invention. Resource access information 120 further comprises regions list 202, medical facilities list 204, users list 206 and emergencies list 208. These lists specify regions, medical facilities, users and emergencies that can access resource details 116. A client 210 associated with region A tries to retrieve resource information for region B. The access control module 122 first determines the region of client 210. Next, access control module 122 retrieves a list of resources that have region A in their regions list 202 and belong to region B. This resource availability of these resources is then passed to client 210. In another embodiment of the present invention, client 212 associated with medical facility XYZ tries to retrieve availability information of one resource. The access control module 122 determines if that resource has medical facility XYZ in its medical facilities list 204. In case the medical facility is present in medical facilities list 204, resource details 116 for that resource are sent to client 212. In another embodiment, client 214 associated with region C requests resource information for resources in region C. The access control module 122 retrieves a list of resources in region C. In this case, access control module does not check to see if resources have given access to region C, since a client of region C requests to view resources of region C. In another embodiment, access control module 122 may first determine if the resources have region C in their regions list 202 before sending the resource information to client 214.

In another embodiment of the present invention, resource information requested by client 214 is not present in database 112. In this case, resource interface 124 connects with resource stores 216 and 218 to retrieve the requested information. Resource stores 216 and 218 are also connected to server 102 by means of network 110.

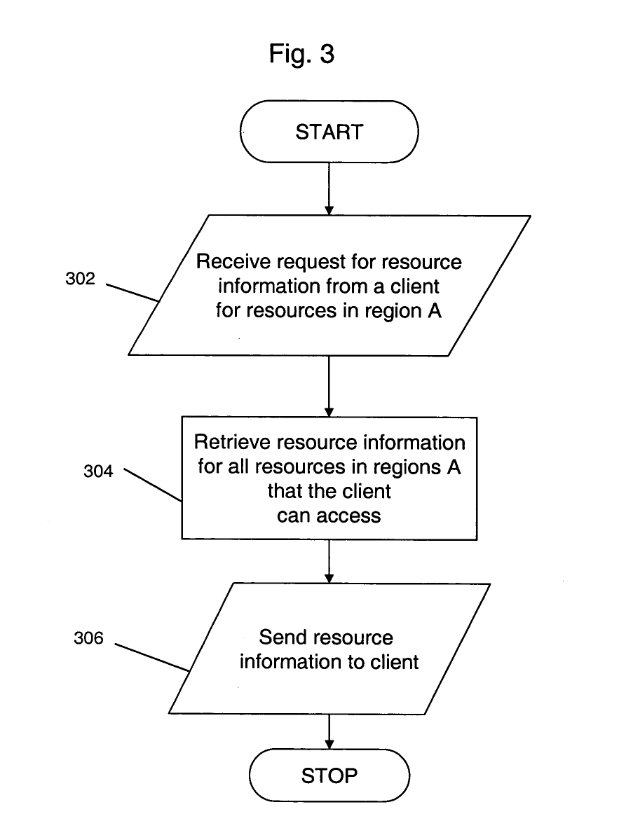

FIG. 3 is a flowchart depicting the steps of retrieving resource information of a region by a client associated with the same region, in accordance with an embodiment of the present invention. A client that is associated with a given region sends a request to view resource information for the same region, in step 302. The system retrieves all resources that belong to that region and also have specified the same region in their regions list 202, in step 304. The resource information from all the retrieved resources is then sent to the client requesting the resource information, in step 306. In an embodiment of the present invention, the client requests resource information only for a certain type of resource. In this case, the resource information is filtered and only the requested resource information is forwarded to the client. In another embodiment of the present invention, the client only requests resource information from a single resource. In this case, the resource information for that resource is retrieved after verifying that the client has access to that resource information.

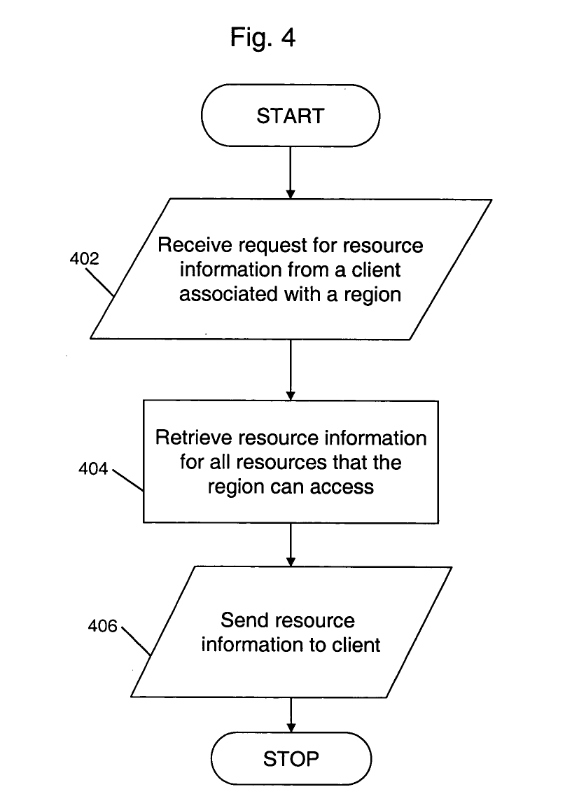

FIG. 4 is a flowchart depicting the steps of retrieving resource information of a region by a client associated with another region, in accordance with an embodiment of the present invention. A client that is associated with a given region sends a request to view resource information for another region, in step 402. The system retrieves all resources that belong to the second region and also have specified the first region in their regions list 202, in step 404. The resource information from all the retrieved resources is then sent to the client requesting the resource information, in step 406. In an embodiment of the present invention, the client requests resource information only for a certain type of resource. In this case, the resource information is filtered and only the requested resource information is forwarded to the client. In another embodiment of the present invention, the client only requests resource information from a single resource. In this case, the resource information for that resource is retrieved after verifying that the client has access to that resource information.

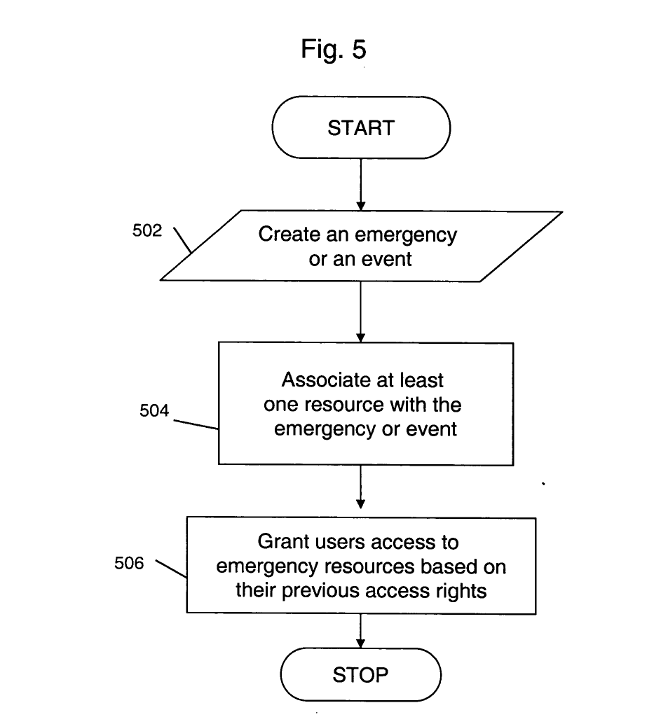

FIG. 5 is a flowchart depicting the steps involved in giving access to resource information to a user for a specific event, in accordance with an embodiment of the present invention. First a supervisor needs to create an emergency or event in the system. This is depicted as step 502. Subsequently, the supervisor associates one or more resources with the emergency or event, at step 504. At step 506, the access rights of users are updated to provide access to the resources associated with the created emergency or event based on the users' previous access rights. In another embodiment of the present invention, instead of creating an emergency, the supervisor can specify a time frame for which the list of resources retrieved in step 506 will be available to a region, user or medical facility.

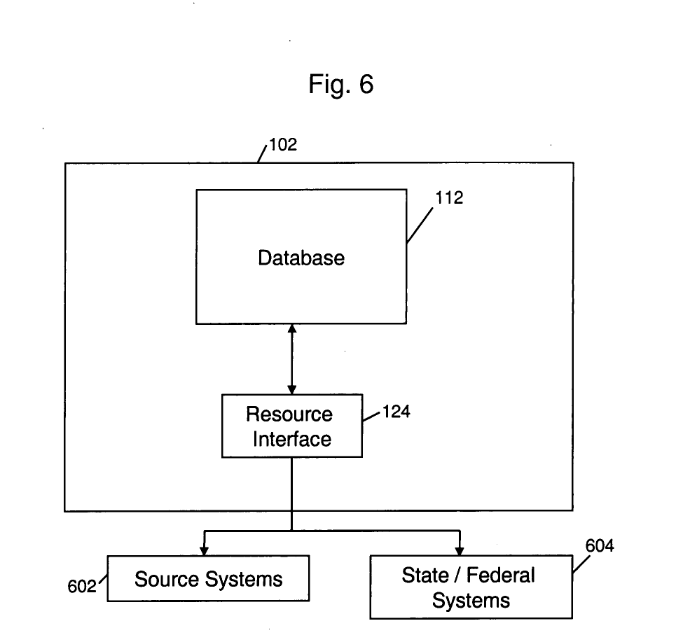

FIG. 6 is a schematic view of the system for communicating with external state and federal resource databases, in accordance with an embodiment of the present invention. Resource interface exchanges resource information with external systems such as source systems 602 and federal or state systems 604. Source systems can be other similar systems that store resource information. In an embodiment, source systems 602 are CIMS or HAN system. In an embodiment, federal or state systems 604 are compatible with HAVE standards. Resource interface connects to the systems 602 and 604 via a network, such as the internet and exchanges data by querying the systems 602 and 604. The systems return data on the basis of the query sent and this data is stored in database 112.

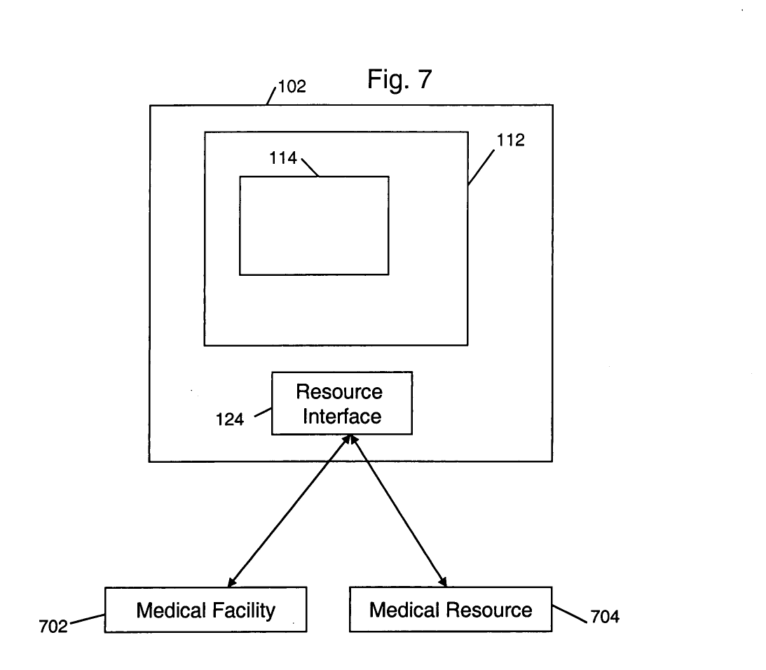

FIG. 7 is a schematic view of the system for allowing medical facilities to update medical resource information, in accordance with an embodiment of the present invention. Medical facility 702 communicates with resource interface 124 to update resource details 116 such as availability, timing, etc. Resource interface 124 is also capable of communicating with medical resource 704 such that medical resource directly sends resource interface 124, updated resource information. The resource interface queries the resource in a syntax and language that is compatible with the resource. The returned information is stored in database 112.

In an embodiment of the present invention, users of the system are provided with modify and update rights for the stored resource information. These rights are assigned to the users on the basis of the medical facility or region with which they are associated, similar to which access rights to the users are assigned.

Certain modifications and improvements will occur to those skilled in the art upon a reading of the foregoing description. Also, the resource management system is operable for use by first-alert responders to a medical crisis scene for coordinating patient-related data with resource-related data for optimizing system utilization and for making decisions regarding directing and transporting patients to suitable medical facilities having capabilities and capacity for treating each patient, wherein the system provides for use “on-site” of a disaster, accident, or location of a patient or at a medical facility.

All modifications and improvements have been deleted herein for the sake of conciseness and readability but are properly within the scope of the following claims.

What is claimed is:

1. A method for providing resource information to at least one user, the resource information comprising availability of resources associated with one or more facilities in one or more regions, the at least one user being associated with at least one region, the method comprising the steps of:
a. providing the resource information for at least one first region along with a list of at least one second region that can access the resource information for the at least one first region,
b. the at least one user sending a request for viewing resource information for the at least one first region
c. verifying that the at least one region that the user is associated with is in the list of at least one second region with access to the resource information of the at least one first region,
d. providing the resource information of the at least one first region to the at least one user.

2. The method of claim 1, wherein the resource information includes data elements required by HAVE standards.

3. The method of claim 1, wherein a at least one second user associated with the at least one first region requests resource information for the at least one first region.

4. The method of claim 3, further comprising the step of providing the resource information of the at least one first region to the at least one second user.

5. The method of claim 1, further comprising the step of forwarding the request for resource information to an external resource information store.

6. The method of claim 5, wherein the external data store is a data store used to support a Crisis Information Management System (CIMS) system.

7. The method of claim 5, wherein the external data store includes data elements required by Hospital Availability Exchange (HAVE) guidelines.

8. The method of claim 1, further comprising the step of updating the resource information by at least one medical facility providing the information.

9. The method of claim 8, wherein the information is automatically updated at predetermined intervals.

10. The method of claim 8, wherein the information is automatically updated at predetermined changes to the resource information.

11. The method of claim 8, wherein the information is updated manually by a user at the at least one medical facility.

12. The method of claim 1, wherein the information is updated as per Hospital Availability Exchange (HAVE) guidelines.

13. The method of claim 1, further comprising the step of exporting the resource information to an external database.

14. The method of claim 13, wherein the external database is a state or federal Hospital Availability Exchange (HAVE) system.

15. The method of claim 13, wherein the external database is a Crisis Information Management Systems (CIMS) system.

16. The method of claim 13, wherein the external database is a mapping/Geographic Information System (GIS).

17. The method of claim 1, wherein the resource information includes any relevant information about at least one medical facility, the data selected from the group consisting of data relating to capability and capacity of the at least one medical facility, medication and equipment availability and status, space/bed availability, and personnel-related data, including but not limited to skills, education, location, performance history, availability, and combinations thereof.

18. The method of claim 1, wherein the resource information includes any relevant information about at least one resource, the data selected from the group consisting of data relating to capability and capacity of the at least one resource, availability and status of the at least one resource.

19. A method for providing resource information to a user during an emergency, the resource information comprising availability of resources in one or more facilities in one or more regions, the user being associated with at least one region and at least one emergency, the method comprising the steps of:
a. providing the resource information for at least one region along with a list of users associated with at least one emergency that can access the resource information for the at least one region,
b. the user sending a request for viewing resource information for the at least one region,
c. verifying that the at least one emergency that the user is associated with is in the list of at least one emergencies with access to the resource information being requested,
d. providing the resource information to the user.

20. A method for providing resource information to a user, the resource information comprising availability of resources in one or more facilities in one or more regions, the user being associated with at least one region, the method comprising the steps of:
a. creating an alert, the alert corresponding to an emergency,
b. associating at least one resource with the alert,
c. the user sending a request for viewing available resources for the alert,
d. verifying that the access rights of the user provide for viewing the resource information of the alert based on access rights specified for the resources being requested for the alert, and
e. providing the resource information to the user.

21. A method for providing resource information to at least one user, the resource information comprising availability of resources in one or more facilities in one or more regions, the at least one user being associated with at least one region, the method comprising the steps of:
a. providing the resource information for at least one first region along with a list of at least one second region that can access the resource information for the at least one first region, wherein the resource information includes data elements required by HAVE standards
b. the at least one user sending a request for viewing resource information for the at least one first region,
c. verifying that the at least one region that the user is associated with is in the list of at least one second region with access to the resource information of the at least one first region, and
d. providing the resource information of the at least one first region to the at least one user.

22. The method of claim 21, further comprising the steps of providing the resource information for the at least one first region to a central resource store in a manner compatible with HAVE standards.

23. A system for providing resource information to a user, the user associated with at least one facility in at least one region, the resource information comprising availability of resources in at least one facility in at least one region, the system comprising:
a. at least one database, the at least one database storing the resource information for at least one facility,
b. an access control module for controlling access to the resource information stored in the database,
c. at least one terminal for viewing the resource information,
d. network for connecting the at least one database with the at least one terminal,
e. at least one second database for storing a list of at least one region that can access resource information for the at least one facility.

24. The system of claim 23, further comprising a resource interface module for requesting resource information from an external source.

25. The system of claim 24, wherein the resource interface module requests information from a Hospital Availability Exchange (HAVE) guideline compatible source.

26. The system of claim 24, wherein the resource interface module requests information from a Crisis Information Management System (CIMS) source.

27. The system of claim 23, wherein the at least one client is selected from a group comprising of a personal computer, a laptop, a PDA, a mobile phone and a tablet pc.

28. The system of claim 23, wherein the at least one database storing the resource information stored the resource information in a manner compatible with HAVE standards.
